(19) United States
(12) Patent Application Publication
(10) Pub. No.: US 2014/0040809 A1
(43) Pub. Date: Feb. 6, 2014

(54) SYSTEM AND METHOD FOR INPUTTING CHARACTERS ON SMALL ELECTRONIC DEVICE

(71) Applicant: Pang LEE, Tseung Kwan O (HK)

(72) Inventor: Pang LEE, Tseung Kwan O (HK)

(73) Assignee: FRANKLIN ELECTRONIC PUBLISHERS, INCORPORATED, Burlington, NJ (US)

(21) Appl. No.: 13/563,825

(22) Filed: Aug. 1, 2012

(51) Int. Cl. G06F 3/048

(52) U.S. Cl. 715/773

(57) ABSTRACT

A system and method for the inputting of characters for processing by very small electronic devices based on correlated movement of such a device by the user to access groupings of certain characters and the subsequent choice by said user of the proper character to be entered by touch screen input. In the preferred embodiment each of the twenty six letters of the Roman alphabet are intelligently marshaled into a default grouping and three selectable groupings, each of which being easily accessible by a user simply by moving the electronic device in a prescribed manner.

### FIELD OF THE INVENTION

The present invention relates in general to methods for inputting characters, that is, letters and numbers, into and for processing by electronic devices that have small footprints that perforce do not allow for the use of standard keyboard inputting techniques and more specifically to correlating the user's movements of such devices to the selection of groupings of characters to be input by use of touch screen displays incorporated in such devices.

### BACKGROUND OF THE INVENTION

As electronic devices have become smaller and smaller in line with the continuing miniaturization of components for such devices, a problem has arisen with respect to the input of characters, that is, letters and numbers, to be read and processed by a small device. While touch screen technology for inputting information has supplanted tactile keyboard input as devices have become mobile and, as a result, handheld in nature, the continuing trend for smaller, and in some cases wearable electronic devices, or even bodily implanted devices, has created a need for new input methods and systems in connection with such miniaturization.

### SUMMARY OF THE INVENTION

The instant invention solves the problem by providing a system and method for the inputting of characters in very small electronic devices based on correlated movement of the device by the user in order to select certain groupings of letters or numbers and the subsequent choice by the user of the character to be entered via touch screen input.

The preferred embodiment of the system is based on the division of the Roman alphabet into four distinct categories based in part on the shape of the letters. For example, the non-capitalized Roman alphabet letters that are written by starting with a straight stroke, that is, the eight letters - - - “h,” “i,” “j,” “k,” “l” “p” “r,” and “t” - - - are classified as members of a distinct grouping, in the preferred embodiment the so-called second grouping. As will be further described, in the preferred embodiment each of the twenty six letters of the Roman alphabet is intelligently placed into a default grouping or one of three other groupings, each of which is accessible by a user simply moving the electronic device in a predescribed manner.

Other details, objects, and advantages of the present invention will become apparent as the following description of the presently preferred embodiment and presently preferred method of practicing the invention proceeds. This application follows on my earlier application entitled “Wireless Processing System and Method” and is expected to be followed by my application entitled “Child's Wearable Computing Device.”

### BRIEF DESCRIPTION OF THE DRAWINGS

The invention will become more readily apparent from the following description of the preferred embodiment thereof shown, by way of example only, in the accompanying drawings wherein:

FIG. 1 is a frontal view of a small electronic device of the present invention in its preferred embodiment with display front cover removed;

FIG. 2 is the left side view of said device;

FIG. 3 is the right side view of said device;

FIG. 4 is the bottom view of said device;

FIG. 5 is a frontal view of the display front cover of said device;

FIG. 6 is a frontal view of said small electronic device with the display front cover removed having a digitally generated analog watchface displayed on its display screen;

FIG. 7 shows the small electronic device of the preferred embodiment with display front cover affixed thereto as mounted on a wristband to be worn by a child;

FIG. 8 shows the small electronic device of the preferred embodiment as shown in FIG. 6 but mounted on a wristband to be worn by a child with display front cover removed;

FIG. 9 shows the frontal view of said small electronic device having the default grouping of icons of characters displayed on the touch screen display of said device;

FIG. 10 depicts the initial user movement in the process of the preferred embodiment of the present method in changing the grouping of icons of characters as shown on the touch screen display of said device from the default group of icons of characters to a second grouping of icons of characters;

FIG. 11 depicts the final user movement in the process of the preferred embodiment of the present method in changing the grouping of icons of characters as shown on the touch screen display of said device from the default group of icons of characters to the first different grouping of icons of characters;

FIG. 12 shows the frontal view of said small electronic device having said first different grouping of icons of characters shown on the touch screen display of said device;

FIG. 13 depicts the initial user movement in the process of the preferred embodiment of the present method in changing the grouping of icons of characters as shown on the touch screen display of said device from the default group of icons of characters to the second different grouping of icons of characters;

FIG. 14 depicts the final user movement in the process of the preferred embodiment of the present method in changing the grouping of icons of characters as shown on the touch screen display of said device from the default grouping of icons of characters to the second different grouping of icons of characters;

FIG. 15 shows the frontal view of said small electronic device having the second different grouping of icons of characters shown on the touch screen display of said device;

FIG. 16 depicts the initial user movement in the process of the preferred embodiment of the present method in changing the grouping of icons of characters as shown on the touch screen display of said device from the default group of icons of characters to the third different grouping of icons of characters;

FIG. 17 depicts the final user movement in the process of the preferred embodiment of the present method in changing the grouping of icons of characters as shown on the touch screen display of said device from the default group of icons of characters to the third different grouping of icons of characters;

FIG. 18 is a frontal view of device 100 in the state of having been changed to display the third different grouping of icons of characters shown on the touch screen display of said device;

FIG. 19 is a front view of device 100 in the state of the letter “c” having been entered in the first blank space of a three letter word.

### DETAILED DESCRIPTION OF THE INVENTION

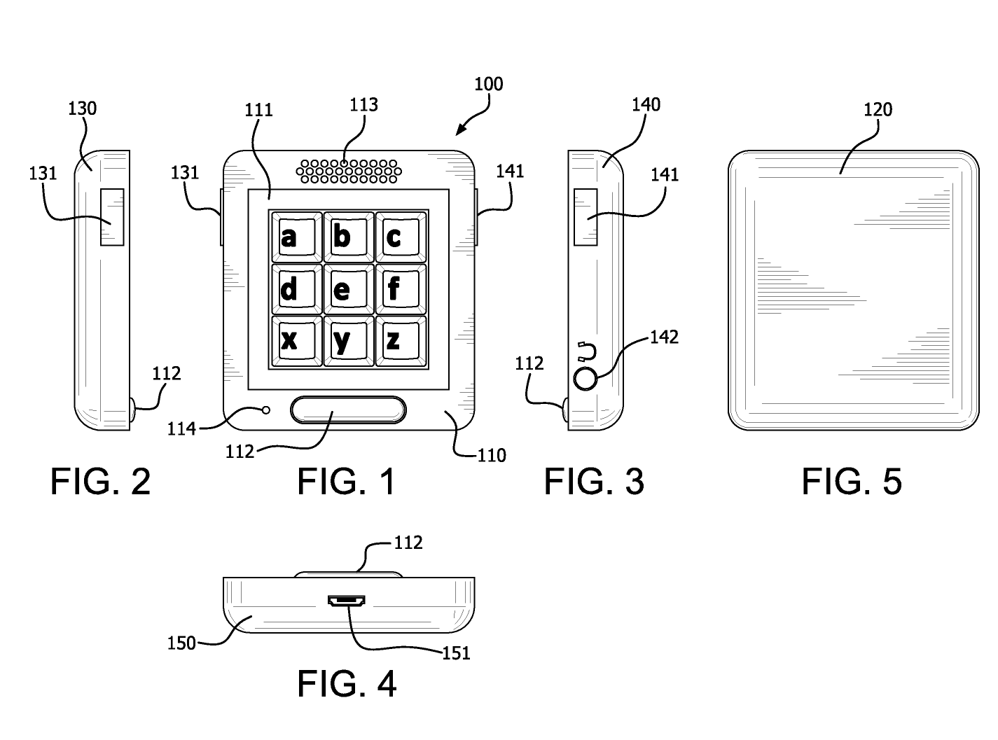

Referring to the drawings wherein like or similar references indicate like of similar elements throughout the several views, there is shown in FIG. 1 a front plan view of the face 110 of the small electronic device 100 of the instant invention with display front cover 120 removed. The face 110 of device 100 has a touch screen display 111 on which in FIG. 1 is shown a set of icons of characters shown in the form of hard keys, which set of icons of characters is referred to as the “default grouping” of icons of characters hereinbelow. At the bottom of the plan view of device 100 and on its face 110 is depicted a depressable control button 112. As will be described hereinbelow, control button 112 can be depressed by the user in order to activate certain motion sensors (to be described infra) built into electronic device 100. Device 100 is also outfitted with a speaker output 113 and a microphone input 114 as well as key inputs 131, being a left side key, and 141, being a right side input key, both of which as shall be discussed in this specification as under the control of application software resident in said device 100 and hence referred to herein as “soft keys.”

FIG. 2 is a view of the left side panel 130 of device 100 showing the front view of soft key 131.

FIG. 3 is a view of the right side panel 140 of device 100 showing the front view of soft key 141 of device 100 and headphone input jack 142 that provides for use of electronic device 100 with headphones, perforce disabling speaker 113 output when utilized.

FIG. 4 is a view of the bottom side panel 150 of device 100 showing control button 112 in perspective view height and shape from below and mini USB port 151 for connection of said device 100 with any one of a variety of computer or electronic products, for input or output of data, or for battery charging in the manner known in the art relative to USB connections generally.

FIG. 5 is the front plan view of display front cover 120 which is constructed in the preferred embodiment to fit over the front of device 100 and can be removed either in its entirety, as in the preferred embodiment, or flipped up on a hinge (not shown herein), in either case to allow viewing, and wanted touching, of the touch screen display 110 of device 100.

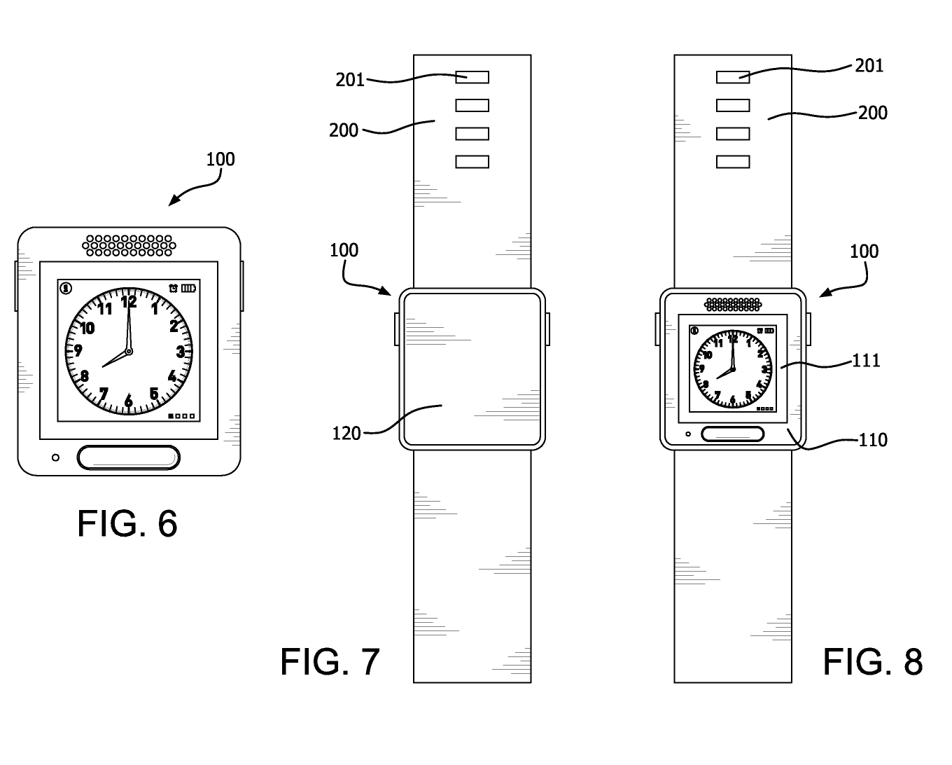

FIG. 6 shows device 100 having a digital representation of an analog wrist watch on its touch screen display 110, as well as icons displayed thereon representing, among other things, an alarm, battery life indicator, and volume setting for speaker/headphone use.

FIG. 7 and FIG. 8 depict the preferred embodiment for a child's “wearing” of small electronic device 100, that is, by attachment of device 100 by well known means to a wrist watchband 200, having normal watchband cutouts 201 for engagement with band tightening fasteners (not shown). FIG. 7 depicts device 100 as attached to said wrist watch band with the face 110 of the device 100 as covered by protective display front cover 120. FIG. 8 shows the combination of the device 100 and the watchband 200 with the face 110 of said device 100 uncovered with touch screen display 111 exposed to present said digitally displayed analog watchface as represented in the plan view of FIG. 6.

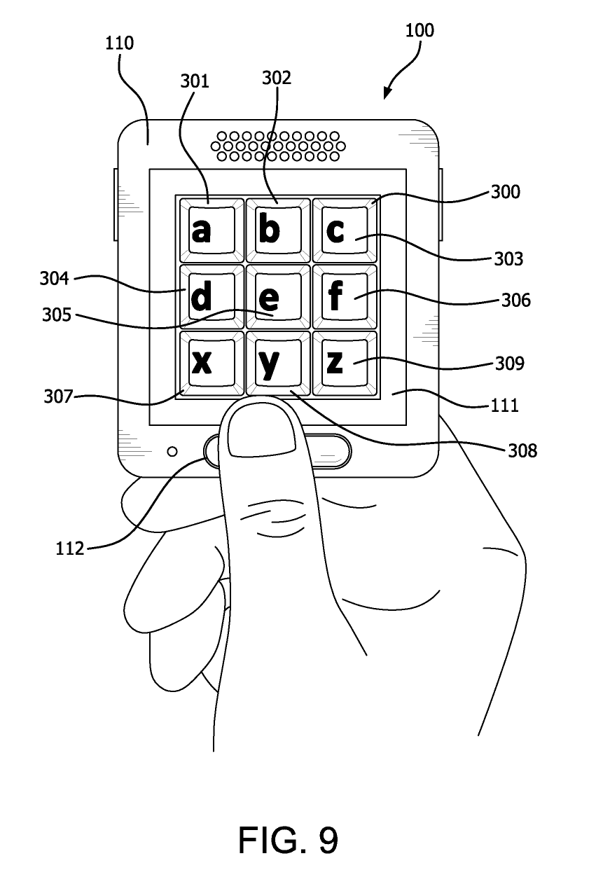

FIG. 9 depicts what is displayed on the touch screen display 111 of face 110 of said device 100 in the case in which control button 112 is depressed by the user's thumb and then released. After release, screen display 111 is populated with icons representative of nine keyboard style keys 300, to wit, key 301 for the small letter “a,” key 302 for the small letter “b,” key 303 for the small letter “c,” key 304 for the small letter “d,” key 305 for the small letter “e,” key 306 for the small letter “f,” key 307 for the small letter “x,” key 308 for the small letter “y,” and key 309 for the small letter “z.” Each of said keys 301 through and including 309 make up separate and independent parts of touch screen 111 and as such are susceptible of touching by the user to input any one of the respective nine characters into the device for processing by device 100 just as if said “keys” were on a hard key computer QWERTY keyboard. Such grouping 300 of said key icons representing said nine characters on said keyboard is referred to herein as the “default grouping” of characters in the preferred embodiment.

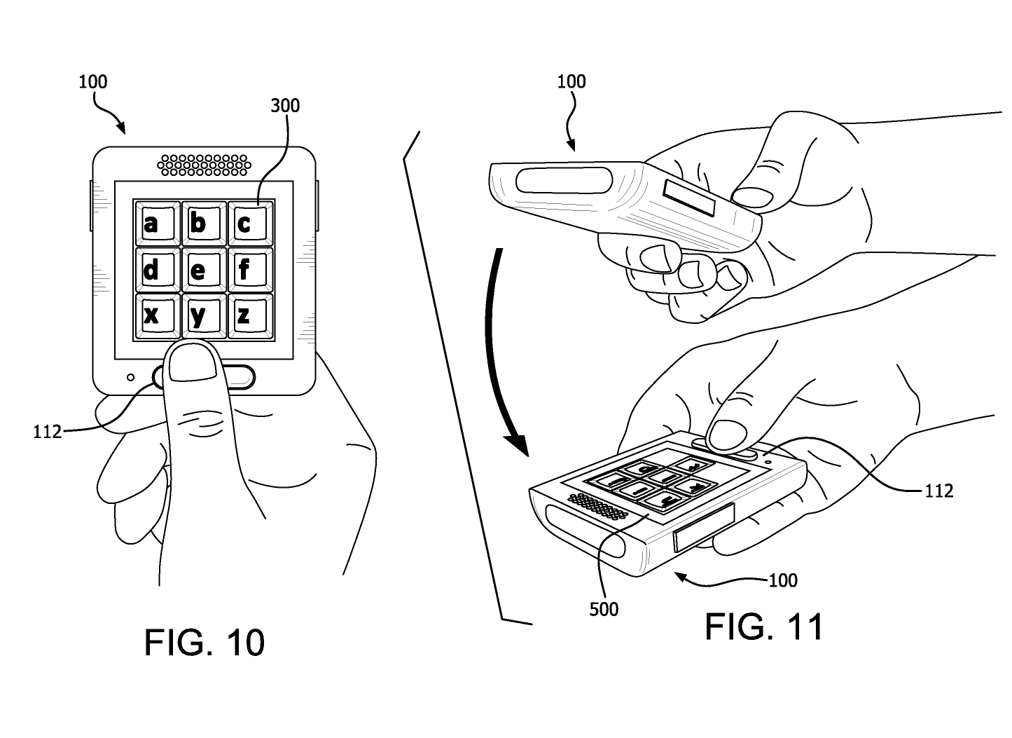

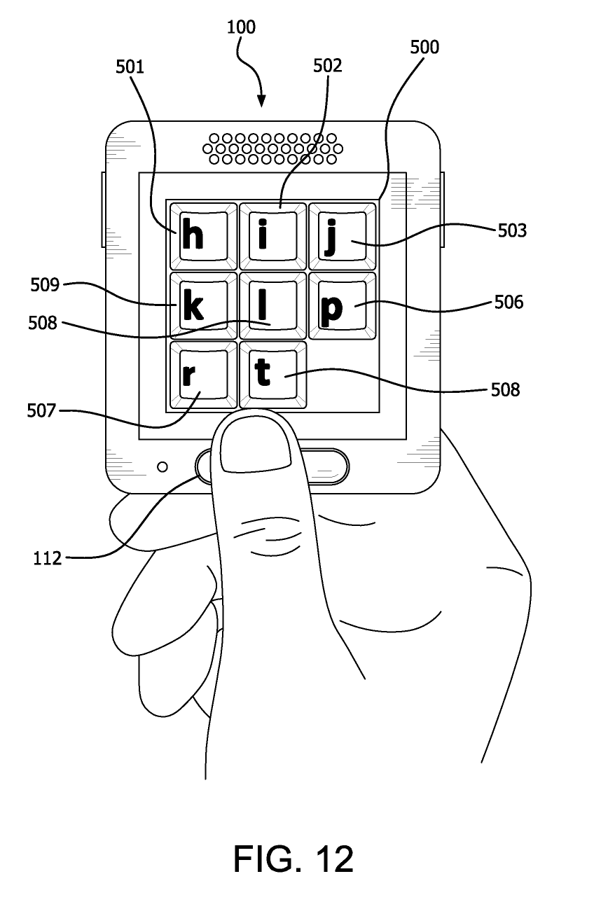

The juxtaposition of FIG. 10 and FIG. 11 depicts the manner in which in the preferred embodiment the default grouping of icons of characters is changed by the user through the method of the instant invention by the user depressing control key 112 as represented in FIG. 10 in order to actuate motion detection circuitry resident in the device (as will be described in detail hereinbelow) to change the default grouping 300 of icons of characters into the second grouping of icons of characters 500. Having depressed said control key 112, the user as is shown in FIG. is moving the device 100 in a straight and downward direction. The straightness of the motion is chosen in the preferred embodiment to remind the user that the default grouping of icons of characters 300 will be changed on the screen display (through the interplay of motion detection means and processing by the electronic device) to a new grouping of icons for letters that are begun with straight lines, to wit, the small Roman letters “h,” “i,” “j,” “k,” “l,” “p,” “r,” and “t,” icons for keys for which letters are shown on screen display 111 of device 100 in both FIG. 11 and in FIG. 12).

FIG. 12 is a frontal view of device 100 in the state of having been changed to display the first different grouping of icons of characters, that is, the grouping 500 of icons of keys of the small Roman letters “h” 501, “i” 502, “j” 503, “k” 504, “l” 505, “p” 506, “r” 507, and “t” 508, all of which are formed in writing with pencil and paper by an initial movement of the pencil that is straight and in a downward direction.

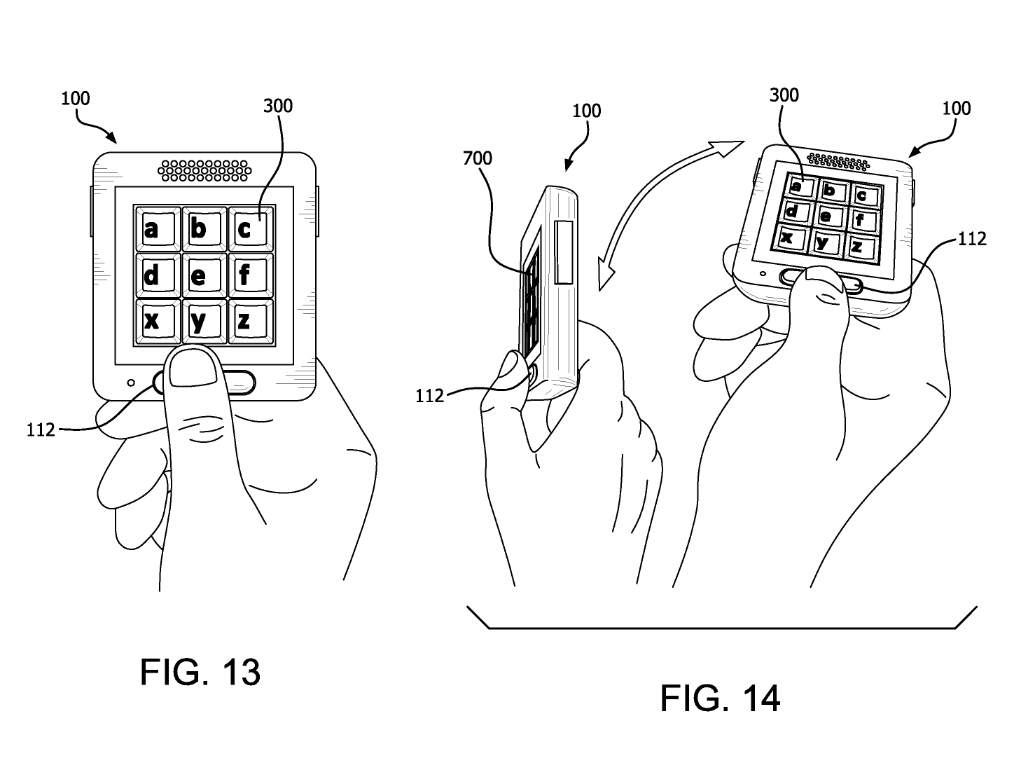

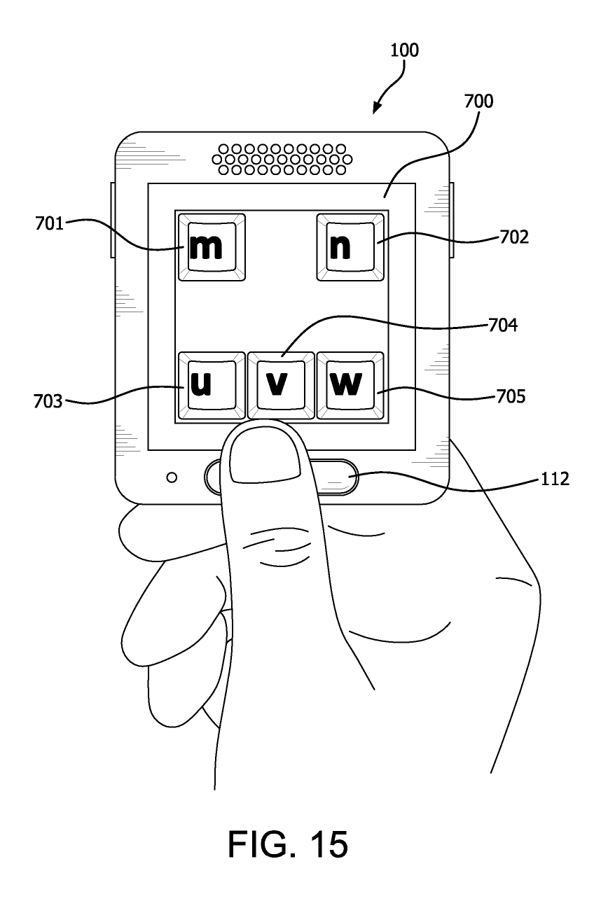

The juxtaposition of FIG. 13 and FIG. 14 depicts the manner in which in the preferred embodiment the default grouping of icons of characters 300 is changed by the user through the method of the instant invention by the user depressing control key 112 as represented in FIG. 13 in order to actuate said motion detection circuitry to change the default grouping of icons of characters 300 into the third grouping of icons, of keys of characters 700. Having depressed said control key 112, the user is shown in FIG. 14 moving the device 100 in a downward direction and to the right. The curved nature of the motion as shown in FIG. 14 is chosen in the preferred embodiment to remind the user that the grouping of icons of characters 300 will be changed on the screen display (through the interplay of motion detection means and processing by the electronic device) to icons for letters that are curved, to wit, the small Roman letters “m,” “n,” “u,” “v,” and “w,” icons for which letters are shown on screen display 111 of device 100 in both FIG. 14 and in FIG. 15).

FIG. 15 is a frontal view of device 100 in the state of having been changed to display the second different grouping of icons of characters 700, that is, the grouping of the small Roman letters “m” 701, “n” 702, “u” 703, “v” 704, and “w” 705, all of which are formed in writing with pencil and paper by a curved motion of the pencil.

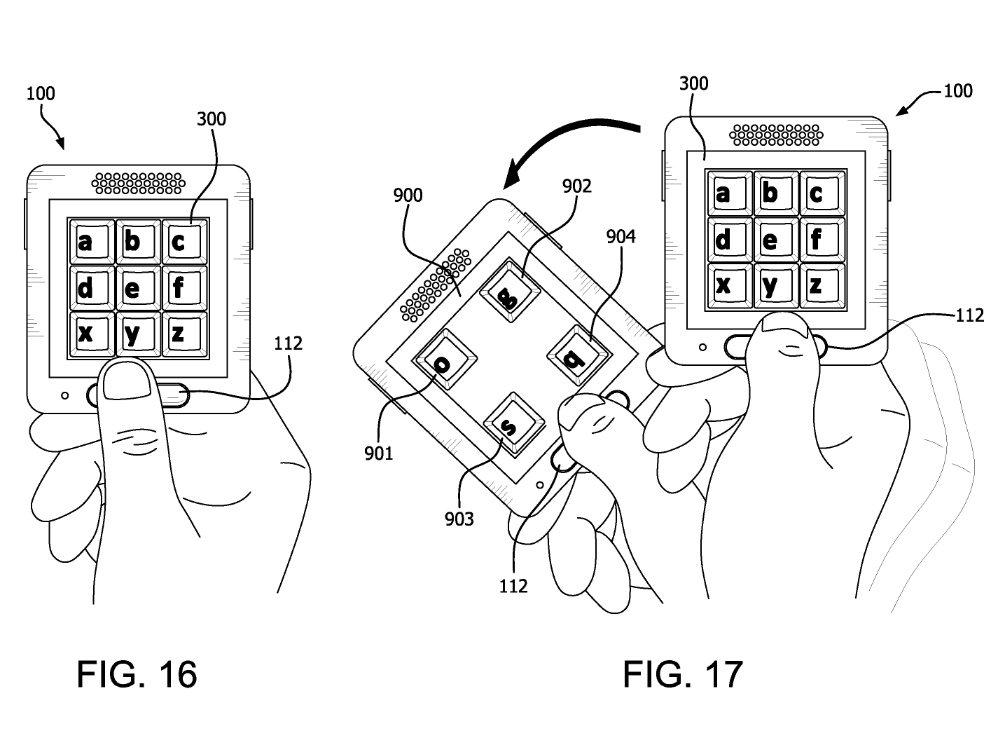

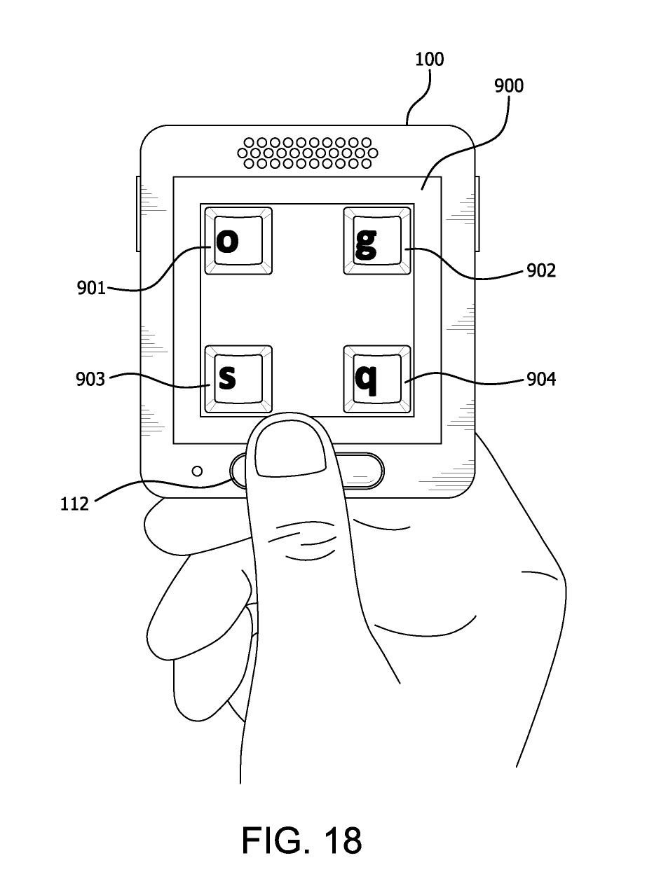

The juxtaposition of FIG. 16 and FIG. 17 depicts the manner in which under the preferred embodiment the default grouping of icons of characters 300 is changed by the user through the method of the instant invention by the user depressing control key 112 as represented in FIG. 16 in order to actuate previously mentioned motion detection circuitry to change the default grouping of icons of characters 300 into the fourth grouping of icons of characters 900. Having depressed said control key 112, the user is shown in FIG. 17 moving the device 100 in a counterclockwise direction. Such motion is chosen in the preferred embodiment to remind the user that the grouping of icons of characters 300 will be changed on the screen display (through said interplay of motion detection means and processing by the electronic device) to a grouping 2 icons of keys for letters that are circular in nature, to wit, the small Roman letters “o,” “g,” “s,” and “q,” icons for which letters are shown on screen display 111 of device 100 in both FIG. 17 and in FIG. 18).

FIG. 18 is a frontal view of device 100 in the state of having been changed to display the third different grouping of icons of characters, that is, the grouping of the small Roman letters “o” 901, “g” 902, “s” 903, and “q” 904, all of which are formed in writing with pencil and paper by a circular movement.

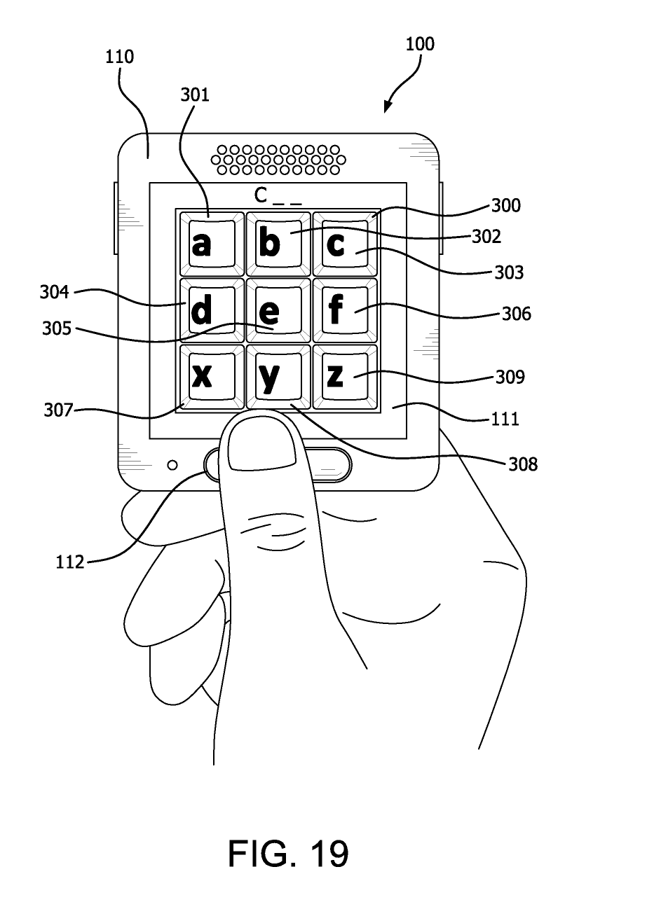

FIG. 19 is a frontal view of device 100 in the state of having had the letter “c” entered into the first blank space of a three letter word.

In the preferred embodiment of the present invention, the small electronic computing device 100 measures approximately 50 mm×40 mm×15 mm in order that the device may be easily “worn” by a child. With such a small footprint, even with a touch screen display 111 measuring 1.54″ diagonally that is mounted on the front 110 of the device it is difficult, if not impossible, to make available a useable compete QWERTY keyboard on such display for the entry of Roman letters and Arabic numbers. The present invention solves the problem of entering such characters on such a small device. The device 100 utilizes any one of a number of commercially available 16-bit microprocessors and has NAND flash memory of approximate size of 4 GBytes resident therein. The motion detection circuitry used in the device comprises an accelerometer working together with a magnetometer. The accelerometer is a standard MEMS device used in a variety of handheld products, such as the commercially available Bosch BMA 222, and the magnetometer, also a standard MEMS device, is of the general nature of the commercially available part ALPS HSCDT DOO4A. The accelerometer detects movement of the device and the magnetometer identifies the direction of the movement of the device. Working together, the circuitry can distinguish movement straight down as opposed to movement that is down and to the right or movement that is counterclockwise as necessary in the preferred embodiment of the instant invention. Soft keys 131 and 141 are programmable by the user and are under the control of application software resident in said device to be used in order to facilitate certain functions, to wit, “enter,” “esc,” and “game mode.”

The preferred embodiment of the invention is based on providing learning activities for young children in the age range of three to eight years. An example of a learning activity is a spelling teaching program. The device 100 is programmed to speak out loud via its speaker 113 or through a headphone connected at jack 142 a simple English word, such as, for example purposes only, “cat.” The child upon hearing the word “cat” is prompted to enter the proper spelling of the word on the display screen 111 as a number of blank spaces appear on said display, such as the blanks shown in FIG. 19. On speaking the word “cat,” the device displays as well as the blanks the default grouping of icons 300, that is, icons of keys of the letters “a,” “b,” “c,” “d,” “e,” “f,” “x,” “y,” and “z” as shown in FIG. 9. In the case in which the precocious three year old knows that “cat” begins with the letter “c” and touches key 303 to enter the letter “c” the screen display changes to that as shown in FIG. 19 in which the first blank has been filled with the small letter “c.” If the child knows that the next letter should be “a,” he or she can touch key 301 to enter the proper letter into the second blank. But for sake of example, if the child believes the next letter to be other than as shown on the default screen, in this example the letter “h,” the child, knowing that the small letter “h” is formed with a downward motion in a straight line, depresses the control button 112 and moves the device 100 in the manner shown in the juxtaposition of FIG. 10 and FIG. 11, that is, downward and in a straight line, causing the default set of icons 300 to change into the set of icons 500 as shown in FIG. 12. The child can then touch icon 501 to enter the small letter “h” into the second blank of the screen display 111. Alternatively, should the child believe the second blank should properly filled in with the letter “m” the child, knowing that the small letter “m” is formed with curved motion, depresses the control button 112 and moves the device 100 in the manner shown in the juxtaposition of FIG. 13 and FIG. 14, that is, downward and to the right, causing the default set of icons 300 to change into the set of icons 700 as shown in FIG. 15. The child can then touch icon 701 to enter the small letter “m” into the second blank on the display screen 111. Alternatively, should the child believe the second blank should properly filled in with the letter “o” the child, knowing that the small letter “o” is formed with circular motion, depresses the control button 112 and moves the device 100 in the manner shown in the juxtaposition of FIG. 16 and FIG. 17, that is, in a counterclockwise direction, causing the default set of icons 300 to change into the set of icons 900 as shown in FIG. 15. The child can then touch icon 901 to enter the small letter “m” into the second blank on the display screen 111.

As can be appreciated by anyone skilled in the art, the entry of numbers or other characters, that is, letters other than Roman alphabet small letters, can be accomplished in a similar manner to that described herein of the preferred embodiment. Likewise, the composition of the default grouping and the groupings other than the default grouping can be different from that described in the preferred embodiment. Also, numbers can be entered simply by moving or tapping the device the number of times equal to the number that is desired to be entered, which movement or tapping can be easily identified by the accelerometer MEMS and translated into the entry of the number on the screen display 111 for processing by the device.

As can be appreciated, the method spelt out above is usable in many different environments having small footprint electronic devices, not only in the area of endeavor that constitutes learning tasks or games for children.

I claim:

1. A method for inputting characters into and for processing by a small electronic computing device having a touch screen display, a motion detector, and a pressure sensitive switch comprising:
first depressing said switch to show a default grouping of icons of characters on said display;
in the case in which the desired character is shown in such default grouping, touching one of the icons representing said default characters on said display to enter said character into and for processing by said device or otherwise moving said device in a prescribed manner to show a different grouping of icons representing characters on said display;
touching one of said icons characters shown in a said different grouping of said icons of said characters on said display to enter said character into and for processing by said device; and
repeating said first step and said following steps to enter as many additional characters into and for processing by said device as needed in order to complete the entry of a complete word into and for processing by said device.

2. The method of claim 1 in which said default grouping of icons representing characters is comprised of the character set of the small letters “a,” “b,” “c,” “d,” “e,” “f,” “x,” “y,” and “z.”

3. The method of claim 1 in which the number of groupings of characters other than said default grouping is three.

4. The method of claim 2 in which the number of groupings of characters other than said default grouping is three.

5. The method of claim 3 in which a grouping of icons of characters, other than said default grouping, is accessed by moving said device in a straight line in a downward direction.

6. The method of claim 4 in which a grouping of icons of characters, other than said default grouping, is accessed by moving said device in a straight line in a downward direction.

7. The method of claim 6 in which said grouping of icons representing characters is comprised of the character set of the small letters “h,” “i,” “j,” “k,” “l,” “p,” “r,” and “t.”

8. The method of claim 3 in which a grouping of icons of characters, other than said default grouping, is accessed by moving said device to the right and in a downward direction.

9. The method of claim 4 in which a grouping of icons of characters, other than said default grouping, is accessed by moving said device to the right and in a downward direction.

10. The method of claim 9 in which said grouping of icons of characters is comprised of the character set of the small letters “m,” “n,” “u,” “v,” and “w.”

11. The method of claim 3 in which a grouping of icons of characters, other than said default grouping, is accessed by moving said device in a counterclockwise direction.

12. The method of claim 4 in which a grouping of icons of characters, other than said default grouping, is accessed by moving said device in a counterclockwise direction.

13. The method of claim 12 in which said grouping of characters is comprised of the character set of the small letters “o,” “g,” “s,” and “q.”

14. The method of claim 1 in which the icons representing characters on said screen display replicate the look of hard keys.

15. A method for inputting characters into and for processing by a small electronic computing device having a touch screen display, a motion detector, and a pressure sensitive switch comprising:
first depressing said switch to show a default grouping of icons representing the character set composed of the small letters “a,” “b,” “c,” “d,” “e,” “f,” “x, ” “y,” and “z” on said display;
in the case in which “a,” “b,” “c,” “d,” “e,” “f,” “x,” “y,” or “z” are the character desired to be entered into for processing by said device touching one of the icons representing said default characters on said display to enter said character into and for processing by said device or, otherwise moving said device in a prescribed manner to show one of three different groupings of icons representing characters on said display, which three different groupings are composed of the following character sets: first different grouping composed of the character set of small letters “h,” “i,” “j,” “k,” “l,” “p,” “r,” and “t;” second different grouping composed of the character set of small letters “m,” “n,” “u,” “v,” and “w;” and third different character set composed of the set of small letters “o,” “g,” “s,” and “q;”
touching one of said icons representing characters shown in one of said different groupings so chosen of said icons of said characters on said display to enter said character into and for processing by said device; and
repeating said first step and said following steps to enter as many additional characters into and for processing by said device as needed in order to complete the entry of a complete word into and for processing by said device.

16. In a computing system comprising a small electronic computing device, the improvement for inputting characters to be processed by said small electronic device having a touch screen display, a motion detector, and a pressure sensitive switch whereby characters are input for processing by said device by touching icons representing characters in separate groupings of icons of said characters in groupings that allow for the display of less than the entirety of the universe of said characters on said display.

17. The improvement of claim 16 in which the separate groupings number four.

18. The improvement of claim 16 in which one of the separate groupings is a default grouping.

19. The improvement of claim 17 in which said four separate groupings consist of a default grouping of the character set composed of the small letters “a,” “b,” “c,” “d,” “e,” “f,” “x,” “y,” and “z;” and three different groupings.

20. The improvement of claim 18 in which said default grouping consists of the character set composed of the small letters “a,” “b,” “c,” “d,” “e,” “f,” “x,” “y,” and “z.”

21. The improvement of claim 19 in which a first different grouping is composed of the character set of small letters “h,” “i,” “j,” “k,” “l,” “p,” “r,” and “t;” a second different grouping is composed of the character set of small letters “m,” “n,” “u,” “v,” and “w;” and a third different character set is composed of the set of small letters “o,” “g,” “s,” and “q.”

22. The improvement of claim 18 in which the default grouping appears on said touch screen display in the case in which the pressure sensitive button is depressed.

23. The improvement of claim 19 in which the default grouping appears on said touch screen display in the case in which the pressure sensitive button is depressed.

24. The improvement of claim 18 in which the default grouping is replaced on the screen display by one of the three different grouping by moving the device in a prescribed manner.

25. The improvement of claim 19 in which the default grouping is replaced on the screen display by one of the three different grouping by moving the device in a prescribed manner.

26. The improvement of claim 18 in which the default grouping is replaced on the screen display by the first different grouping by moving the device in a straight line and in a downward direction.

27. The improvement of claim 19 in which the default grouping is replaced on the screen display by the first different grouping by moving the device in a straight line and in a downward direction.

28. The improvement of claim 18 in which the default grouping is replaced on the screen display by the second different grouping by moving the device to the right and in a downward direction.

29. The improvement of claim 19 in which the default grouping is replaced on the screen display by the second different grouping by moving the device to the right and in a downward direction.

30. The improvement of claim 18 in which the default grouping is replaced on the screen display by the third different grouping by moving the device in a counterclockwise direction.

31. The improvement of claim 19 in which the default grouping is replaced on the screen display by the third different grouping by moving the device in a counterclockwise direction.
